(19) United States
(12) Patent Application Publication
(10) Pub. No.: US 2013/0129598 A1
(43) Pub. Date: May 23, 2013

(54) SILICON CARBIDE AND METHOD FOR MANUFACTURING THE SAME

(71) Applicants: Jung Eun Han, Seoul (KR); Byung Sook Kim, Seoul (KR)

(72) Inventors: Jung Eun Han, Seoul (KR); Byung Sook Kim, Seoul (KR)

(73) Assignee: LG INNOTEK CO., LTD., Seoul (KR)

(21) Appl. No.: 13/812,763

(22) PCT Filed: Jul. 25, 2011
(86) PCT No.: PCT/KR11/05482

§ 371 Date: Jan. 28, 2013

(30) Foreign Application Priority Data
Jul. 26, 2010 (KR) 10-2010-0072129

(51) Int. Cl. C01B 31/36

(52) U.S. Cl. CPC C01B 31/36
USPC 423/345

(57) ABSTRACT

Provided is a method for manufacturing silicon carbide. The method includes mixing a dry silicon source, a solid carbon source, and a binder with each other and heating the mixed source to form silicon carbide.

### TECHNICAL FIELD

The present disclosure relates to silicon carbide and a method for manufacturing the same.

### BACKGROUND ART

Silicon carbide SiC has physical and chemical stability and superior heat resistance and thermal conductivity. Thus, the silicon carbide has good thermal stability and strength at high temperature and superior abrasion resistance. Accordingly, the silicon carbide is being widely used in manufacturing fields of high-temperature materials, high-temperature semiconductors, abrasion-resistant materials, automotive components, etc.

The silicon carbide may be manufactured by heating a mixture of sources such as a silicon source and a carbon source. Here, it is required to improve productivity so that a large amount of silicon carbide is obtained in a process for manufacturing silicon carbide once.

### DISCLOSURE OF INVENTION

### Technical Problem

Embodiments provide a process for manufacturing silicon carbide which is capable of improving productivity and silicon carbide manufactured using the foregoing process.

### Solution to Problem

In one embodiment, a method for manufacturing silicon carbide includes: mixing a dry silicon source, a solid carbon source, and a binder with each other; and heating the mixed source to form silicon carbide.

In another embodiment, a method for manufacturing silicon carbide includes: mixing a dry silicon source, a solid carbon source, and water, alcoholic or acetone with each other; and heating the mixed source to form silicon carbide.

The silicon carbide according to the embodiments may be manufactured through the above-described methods for manufacturing the silicon carbide.

### Advantageous Effects of Invention

According to the method for manufacturing the silicon carbide, the solid carbon source and the dry silicon source may cohere to each other using the solvent containing the binder or the water, isopropyl alcohol, methanol, ethanol, or acetone to increase the amount of mixed source put into the high-temperature furnace. Thus, the amount of silicon carbide which can be obtained in the method for manufacturing the silicon carbide once may increase. Therefore, the productivity may be improved.

### BRIEF DESCRIPTION OF DRAWINGS

FIG. 1 is a flowchart of a process for manufacturing silicon carbide according to an embodiment.

### MODE FOR THE INVENTION

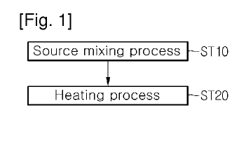

Hereinafter, embodiments of the present invention will be described in detail with reference to the accompanying drawings. A process for manufacturing silicon carbide according to first and second embodiments is described below with reference to FIG. 1. FIG. 1 is a flowchart of a process for manufacturing silicon carbide according to first and second embodiments.

Referring to FIG. 1, the process for manufacturing the silicon carbide according to the first and second embodiments includes a source mixing process ST10 and a heating process ST20.

The process for manufacturing the silicon carbide according to the first embodiment will be described in detail.

In the source mixing process ST10, a dry silicon (Si) source, a solid carbon (C) source, and a binder are prepared and then mixed with each other. Here, the binder is dissolved in a solvent, and then the dry Si source and the solid C source are added into the solvent to mix the sources.

The dry Si source may include various materials containing Si. For example, the Si source may include silica. Also, silica powder, silica sol, silica gel, quartz powder may be used as the Si source.

The solid C source may include various materials containing C. Graphite, carbon black, carbon nano tube (CNT), and fullerene (C₆₀) may be used as the solid C source.

The binder may include various materials in which the solid C source and the dry Si source can cohere to each other. The binder may include an oligomer or a polymer. The oligomer may be a carbon-based oligomer. The oligomer or the polymer may include a phenol-based resin, an acrylic-based resin, a polyurethane-based resin, a polyvinyl alcohol-based resin, a poly glycolic-based resin, and an epoxy-based resin.

A molar ratio (hereinafter, referred to as “a molar ratio of carbon to silicon”) of carbon contained in the solid C source to silicon contained in the dry Si source may range from about 1.5 to about 3. When a molar ratio of carbon to silicon exceeds about 3, the amount of carbon remaining without reacting with silicon is increased because the amount of carbon is too much. Thus, a recovery rate may be reduced. Also, when a molar ratio of carbon to silicon is less than about 1.5, the amount of silicon remaining without reacting with carbon is increased because the amount of silicon is too much. Thus, a recovery rate may be reduced. That is, a molar ratio of carbon to silicon may be decided in consideration of a recovery rate.

When considering that the dry Si source is volatilized into a gaseous state at a high temperature in the heating process ST20, a molar ratio of carbon to silicon may range from about 2 to about 2.8.

The solid C source and the dry Si source may cohere to each other by the binder to reduce a volume of the mixed source. The binder may have a weight % of about 1 to about 10 with respect to the carbon contained in the solid C source. When the binder content is less than about 1 weight %, it may be difficult to allow the solid C source and the dry Si source to smoothly cohere to each other. Also, when the binder content is greater than about 10 weight %, a rate of carbon to silicon in the mixed source may be out of a desired range due to the carbon contained in the binder. Thus, the amount of remaining carbon may increase. To minimize the amount of remaining carbon, the binder may have a weight % of about 1 to about 3 with respect to the carbon.

The solvent may include various materials in which the binder can be dissolved. For example, an alcoholic-based or water-based material may be used as the solvent.

The solvent to which the dry Si source, the solid C source, and the binder are added may be mixed through simple stirring, attrition mill, ball mill, and then the solvent may be volatilized to obtain mixed powder. The mixed powder may be filtered and recovered by a sieve and dried in a spray driver.

Then, in the heating process ST20, the mixed powder (i.e., the mixed source) are heated to allow the silicon contained in the Si source and the carbon contained in the solid C source to react with each other, thereby forming silicon carbide. In more detail, the mixed powder is weighted in a graphite crucible and put into a high-temperature furnace, e.g., a graphite furnace. Then, the mixed powder is heated within the graphite furnace. Here, the mixed powder may be heated at a temperature equal to or greater than about 1,300° C. for a heating time equal to or greater than about 30 minutes, e.g., a heating time of about 1 hour to about 7 hours. The inside of the high-temperature furnace may be vacuum or inert gas (e.g., argon or hydrogen) atmosphere.

In a process for manufacturing silicon carbide according to another embodiment, only the solvent instead of the binder may be mixed.

The solvent may be an alcoholic-based or water-based material. The solvent may include water, isopropyl alcohol, methanol, ethanol, or acetone.

The solid C source and the dry Si source may cohere to each other by the solvent to reduce a volume of the mixed source. The solvent may have a weight % of about 1 to about 20 with respect to carbon contained in the solid C source. When the solvent content is less than 1 weight %, it may be difficult to allow the solid C source and the dry Si source to smoothly cohere to each other. Also, when the solvent content is greater than about 20 weight %, a rate of carbon to silicon in the mixture may be out of a desired range due to the carbon contained in the solvent. Thus, the amount of remaining carbon may increase. To minimize the amount of remaining carbon, the solvent may have a weight % of about 1 to about 10 with respect to the carbon.

In the process of manufacturing the silicon carbide according to the embodiments, since the solid C source and the dry Si source cohere to each other using the binder, the amount of mixed source having a predetermined volume and to be put into the graphite crucible may increase. Thus, the amount of mixed source put into the high-temperature furnace may increase. For example, when compared that only a general solid C source and dry Si source are used, the amount of mixed source may increase by about 2 times to about 4 times. Accordingly, the amount of silicon carbide which can be obtained in the process for manufacturing the silicon carbide once may increase. Therefore, the productivity may be improved.

Also, since a separate carbonization process is not required, the process for manufacturing the silicon carbide may be simplified.

The silicon carbide manufactured through the above-described may be processed into a predetermined shape through a press sintering process. As a result, the processed silicon carbide may be used as a susceptor in a deposition equipment or a wafer carrier equipment.

Hereinafter, a process for manufacturing silicon carbide according to manufacturing examples and a comparative example will be described in more detail. The manufacturing example is not provided for limiting the scope of the present disclosure but for exemplary purpose only.

Manufacturing Example 1

A phenol resin that is a binder is dissolved in isopropyl alcohol (IPA) that is a solvent. Silica and carbon black are added to the solution to mix the silica and carbon black through ball mill. Here, a molar ratio of carbon contained in the carbon block to silicon contained in the silica may be about 2.0. Slurry of the mixed power is recovered using a sieve, and then the recovered slurry is dried in a dryer.

The mixed powder is filled to about 90% of a graphite crucible having a volume of 0.005 liter. Then, a weight of the mixed source is measured. Thereafter, the mixed source is put into a graphite furnace and heated at a temperature of about 1,800° C. for about 2 hours to manufacture silicon carbide.

Manufacturing Example 2

Silica and carbon black are added to isopropyl alcohol (IPA) to mix the silica and carbon black through ball mill. Here, a molar ratio of carbon contained in the carbon block to silicon contained in the silica may be about 2.0. Slurry of the mixed power is recovered using a sieve, and then the recovered slurry is dried in a spray dryer.

The mixed powder is filled to about 90% of a graphite crucible having a volume of 0.005 liter. Then, a weight of the mixed source is measured. Thereafter, the mixed source is put into a graphite furnace and heated at a temperature of about 1,800° C. for about 2 hours to manufacture silicon carbide.

Comparative Example 1

Silica power and carbon black are mixed with each other through ball mill. Here, a molar ratio of carbon contained in the carbon block to silicon contained in the silica powder may be about 2.0. The mixed powder is recovered using a sieve.

The mixed powder is filled to about 90% of a graphite crucible having a volume of 0.005 liter. Then, a weight of the mixed source is measured. Thereafter, the mixed source is put into a graphite furnace and heated at a temperature of about 1,800° C. for about 2 hours to manufacture silicon carbide.

Recovery ratios and particle sizes (D50) of the silicon carbide manufactured through Manufacturing Examples 1 and 2 and Comparative Example 1 are measured. Table 1 below shows a weight of the mixed source filled in the graphite crucible together with the recovery ratios and the particle sizes (D50) of the silicon carbide in Manufacturing Examples 1 and 2 and Comparative Example 1.

TABLE 1

| | Manufacturing | Manufacturing | Comparative |
|---|---|---|---|
| | Examples 1 | Examples 2 | Example 1 |
| Weight of mixed | 3 | 3 | 1 |
| source [Kg] | | | |
| Recovery ratio [%] | 30 | 30 | 30 |
| Particle size (D50) | 1.5 | 1.3 | 1.4 |

As shown in Table 1, the amount of mixed source weighted using the graphite crucible and put into the graphite furnace that is a high-temperature furnace is about 3 Kg in Manufacturing Examples 1 and 2. On the other hand, it is seen that the amount of mixed source is merely about 1 Kg. Also, it is seen that the particle sizes and recovery ratios of the silicon carbide manufactured in Manufacturing Examples 1 and 2 and Comparative Example 1 are similar to each other. That is, according to Manufacturing Examples 1 and 2, the amount of mixed source put into the high-temperature furnace may increase without deteriorating characteristics of the recovery ratio and particle size. Accordingly, the amount of silicon carbide which can be obtained in the process for manufacturing the silicon carbide once may increase. Therefore, the productivity may be improved.

Features, structures, and effects described in the above embodiments are incorporated into at least one embodiment of the present disclosure, but are not limited to only one embodiment. Moreover, features, structures, and effects exemplified in one embodiment can easily be combined and modified for another embodiment by those skilled in the art. Therefore, these combinations and modifications should be construed as falling within the scope of the present disclosure.

Although embodiments have been described with reference to illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

1. A method for manufacturing silicon carbide, the method comprising:
mixing a dry silicon source, a solid carbon source, and a binder with each other; and
heating the mixed source to form silicon carbide,
wherein the binder has a weight % of about 1 to about 10 with respect to carbon contained in the solid carbon source.

2. The method according to claim 1, wherein the binder comprises an oligomer or a polymer.

3. The method according to claim 2, wherein the binder comprises at least one of materials selected from a group consisting of a phenol-based resin, an acrylic-based resin, a polyurethane-based resin, a polyvinyl alcohol-based resin, a poly glycolic-based resin, and an epoxy-based resin.

4. (canceled)

5. The method according to claim 1, wherein the binder has a weight % of about 1 to about 3 with respect to carbon contained in the solid carbon source.

6. The method according to claim 1, wherein the solid carbon source comprises at least one of materials selected from a group consisting of graphite, carbon black, carbon nano tube (CNT), and fullerene (C₆₀).

7. The method according to claim 1, wherein the dry silicon source comprises silica.

8. The method according to claim 1, wherein, in the mixing of the dry silicon source, the solid carbon source, and the binder, the solid carbon source and the dry silicon source are added to a solvent in which the binder is dissolved.

9. The method according to claim 8, wherein the solvent is an alcoholic-based or water-based material.

10. A method for manufacturing silicon carbide, the method comprising:
mixing a dry silicon source, a solid carbon source, and water, alcoholic or acetone with each other; and
heating the mixed source to form silicon carbide.

11. The method according to claim 10, wherein the alcoholic comprises isopropyl alcohol, methanol, ethanol, or acetone.

12. The method according to claim 10, wherein the solvent has a weight % of about 1 to about 20 with respect to carbon contained in the solid carbon source.

13. The method according to claim 10, wherein the solvent has a weight % of about 5 to about 10 with respect to carbon contained in the solid carbon source.

14. The method according to claim 10, wherein the solid carbon source comprises at least one of materials selected from a group consisting of graphite, carbon black, carbon nano tube (CNT), and fullerene (C₆₀).

15. The method according to claim 10, wherein the dry silicon source comprises silica.
